(19) United States
(12) Patent Application Publication
(10) Pub. No.: US 2021/0398165 A1
(43) Pub. Date: Dec. 23, 2021

(54) Dynamically Changing Promotions Displayed on a Mobile Device and Measuring The Benefit Thereof

(71) Applicant: UPSIDE SERVICES, INC., Washington, DC (US)

(72) Inventors: Joanna Zofia Kochaniak, Needham, MA (US); Alessandro Emilio Orfei, Kensington, MD (US)

(21) Appl. No.: 17/157,043

(22) Filed: Jan. 25, 2021

Related U.S. Application Data
(60) Provisional application No. 62/964,900, filed on Jan. 23, 2020.

(51) Int. Cl. G06Q 30/02; G06F 16/22; G06F 3/14; H04L 29/08

(52) U.S. Cl. CPC G06Q 30/0246; G06Q 30/0267; G06Q 30/0254; G06Q 30/0201; G06Q 10/087; G06Q 30/0255; G06F 16/2291; G06F 3/14; H04L 67/18; G06Q 30/0261

(57) ABSTRACT

In a system for dynamically selecting messages for display on a mobile device, the message to be displayed is selected based on a change in one or more parameters associated with the user of the device. The parameters include a set of promotions previously transmitted to the user device or a purchasing pattern of one or more other users to whom a particular promotion was sent previously.

### CROSS-REFERENCE TO RELATED APPLICATIONS

This application claims priority to and benefit of U.S. Provisional Patent Application No. 62/964,900, entitled “Systems and Method for Dynamically Changing Promotions Displayed on a Mobile Device,” filed on Jan. 23, 2020, the entire contents of which are incorporated herein by reference in its entirety.

### FIELD OF THE INVENTION

This disclosure generally relates to mobile device advertising techniques and, in particular, to techniques for dynamically changing promotions displayed on a mobile device based on a likelihood that the promotion would change user behavior.

### BACKGROUND

Conventional systems that are used for displaying promotions on a mobile device include systems that display non-customized promotions and systems that display promotions that are customized according to user behavior and/or environment. For example, some systems may take into consideration the user location, which is inferred from the location of the user device, and, if the user is determined to be near a particular business, e.g., a restaurant, a cineplex, etc., a coupon for that business may be displayed on the user's device. In addition or alternatively, some systems may take into consideration the user's past browsing history, such as a user who has recently browsed for treadmills is determined to be located near a sporting goods store, etc., in displaying a promotion on the user's mobile device.

These conventional techniques generally do not account, however, for the user's purchasing patterns in connection with a particular vendor. They also do not account for other users' purchasing patterns at that vendor.

### SUMMARY

By taking into account both the purchasing pattern of a particular user at a particular vendor and the purchasing patterns of other users at that vendor, more relevant promotions may be provided to the user. In various embodiments, such purchasing patterns are analyzed to predict that a particular user is likely to purchase a particular product or service, especially if that user is at or near a business selling that particular product or service. Based on this inference, a promotion to be displayed on the user's mobile device may be changed dynamically. Moreover, depending on the action taken by the user, e.g., purchasing the promoted good/service or ignoring the promotion, the benefit that can be specifically attributed to the promotion can be computed, which can lead to an efficient and effective delivery of promotions that may be relevant to the user.

As such, in various embodiments, a system and a method can change the purchasing behavior of customers at retail businesses, using personalized promotions delivered via a mobile application, to deliver measurable incremental profit to the businesses. To this end, the promotions delivered to a mobile device, and displayed thereon via a mobile app, are changed dynamically based on one or more parameters such as the location of a user, time spent at a particular location, prior purchase history (also referred to as purchase pattern) of that particular user, purchasing history of users having purchasing patterns similar to those of the particular user, etc.

In various embodiments, personalized promotions are derived from a novel computer analysis of one or more of the following data items:

historical credit card transaction data owned by the merchant

the current margin amounts for the goods or services being promoted to the user

the current location of the user

the current time of day

the retail businesses that are in the proximity of the user's current location

the historical personalized promotions that have been previously created for the user

The system can dynamically alter the promotions that are presented to the user in the mobile application each time any of the data items above changes. In general, each interaction with the system by a user via the mobile app can result in a new collection of promotions, which is designed to encourage a profitable change to the purchasing behavior of the user at each of the businesses.

This technique include a method for calculating the incremental profit driven to a merchant that may be attributable only to the change in behavior caused by the personalized promotions. The effects of other causes of merchant profit not attributable to the personalized promotions may be removed by the method in various embodiments.

Accordingly, in one aspect, a method is provided for dynamically controlling a display of a remote device. The method includes performing by a server the steps of: receiving from a remote device, a device identifier and a location of the remote device and identifying, using the device identifier, a user of the remote device. The method also includes generating a geo-perimeter based on the location, and selecting a set of one or more business entities within the geo-perimeter. In addition, the method includes generating, based on a device parameter of the remote device, and transmitting thereto, a first command causing a first promotional message to be displayed on the remote device. The first promotional message is based on, at least in part, one or more message-selection parameters.

The method further includes detecting a change in one or more of the message-selection parameter(s), where the change can be one or more of: a change in respective databases of a subset of the selected set of one or more business entities, a change in time of the day, a change in the location of the remote device, or a change in history of promotional messages transmitted to the remote device. Additionally, the method includes generating, based on a device parameter of the remote device, and transmitting thereto, a second command causing a second promotional message to be displayed on the remote device. The second promotional message is based on, at least in part, the change in the one or more of the message-selection parameter(s).

The device parameter may include a type of the remote device or a size of a display of the remote device. In some embodiments, the subset of the selected set of one or more business entities includes a first business entity. A database of the first business entity may include a history of transactions of a number of users with the first business entity, and a change in the database of the first business entity may include a change in the history of transactions. Additionally or in the alternative, a database of the first business entity may include an inventory of several products, and a change in the database of the first business entity may include a change in the inventory.

In some embodiments, a change in the location of the remote device is detected, and the method further includes revising the geo-perimeter based on the changed location, and revising the set of one or more business entities based on the revised geo-perimeter. A change in the history of promotional messages transmitted to the remote device may include one or more of: an entry of the first promotional message in the history of promotional messages; or an entry of a user reaction or non-reaction during a selected time window to the first promotional message.

In another aspect, a system is provided for dynamically controlling a display of a remote device. The system includes a processor, and a memory coupled to the processor and having stored therein instructions which, when executed by the processor, program the processor to: receive from a remote device, a device identifier and a location of the remote device and to identify, using the device identifier, a user of the remote device. The instructions also program the processor to generate a geo-perimeter based on the location, and select a set of one or more business entities within the geo-perimeter. In addition, the instructions program the processor to generate, based on a device parameter of the remote device, and transmit thereto, a first command causing a first promotional message to be displayed on the remote device. The first promotional message is based on, at least in part, one or more message-selection parameters.

The instructions further program the processor to detect a change in one or more of the message-selection parameter(s), where the change can be one or more of: a change in respective databases of a subset of the selected set of one or more business entities, a change in time of the day, a change in the location of the remote device, or a change in history of promotional messages transmitted to the remote device. Additionally, the instructions program the processor to generate, based on a device parameter of the remote device, and transmit thereto, a second command causing a second promotional message to be displayed on the remote device. The second promotional message is based on, at least in part, the change in the one or more of the message-selection parameter(s). In various embodiments, the instructions can program the processor to perform one or more of the additional method steps described above.

In another aspect, a method is provided for determining a baseline for a treatment benefit. The method includes: receiving and storing a purchase pattern during a reference period, of a treated user, in a target vector having one or more fields, where each field corresponds to a respective attribute of the purchase pattern. The method also includes, for each untreated user: allocating in memory, memory space for a respective reference vector, where the reference vector has the same fields as the target vector; and storing in the respective reference vector, a purchase pattern during the reference period, of the untreated user.

The method further includes, for each reference vector, computing a distance thereof with the target vector, where the distance is based on a field-wise comparison of the reference and target vectors. In addition, the method includes selecting reference vectors having respective distances not exceeding a specified threshold, and designating corresponding users as matched users.

In some embodiments, the treated and untreated users include or may be limited to existing users, and the reference period precedes a benefit evaluation period. In some embodiments, the treated and untreated users include or may be limited to new users, and the reference period commences upon a first transaction by the treated user, and precedes a benefit evaluation period. The field-wise comparison may include computing a field difference for each field, and computing the distance may include computing a weighted sum of the field differences. An attribute of the purchase pattern can be one of: an amount purchased during a sub-period of the reference period; a count of transactions during the sub-period; an amount purchased during the sub-period for a selected category; and a count of transactions during the sub-period for the selected category.

In some embodiments, the method further includes receiving and storing a purchase pattern during a benefit evaluation period, of the treated user, in an evaluation vector having one or more fields, where each field corresponds to a respective attribute of the purchase pattern. The method may include, for each matched user, storing in a respective baseline vector having the one or more fields, a purchase pattern during the benefit evaluation period, of the matched user. Furthermore, the method may include, for each field in the one or more fields, averaging corresponding purchase pattern attributes over the baseline vectors to provide a corresponding average baseline purchase pattern attribute; and computing a difference between the evaluation vector and the average baseline purchase pattern attribute, to determine a benefit of a treatment.

In some embodiments, the same memory space is allocated to each reference vector and corresponding baseline vector, to improve memory efficiency. In some embodiments, the method includes allocating in the memory, memory space for each baseline vector, the respective memory spaces of the corresponding reference and baseline vectors being different, to improve processor performance. The benefit evaluation period is typically subsequent to the reference period.

In another aspect, a system is provided for determining a baseline for a treatment benefit. The system includes a processor, and a memory coupled to the processor and having stored therein instructions which, when executed by the processor, program the processor to: receive and store a purchase pattern during a reference period, of a treated user, in a target vector having one or more fields, where each field corresponds to a respective attribute of the purchase pattern. The also program the processor to, for each untreated user: allocate in memory, memory space for a respective reference vector, where the reference vector has the same fields as the target vector; and to store in the respective reference vector, a purchase pattern during the reference period, of the untreated user.

The instructions further program the processor to, for each reference vector, compute a distance thereof with the target vector, where the distance is based on a field-wise comparison of the reference and target vectors. In addition, the instructions program the processor to select reference vectors having respective distances not exceeding a specified threshold, and to designate corresponding users as matched users. In various embodiments, the instructions can program the processor to perform one or more of the additional method steps described above.

### BRIEF DESCRIPTION OF THE DRAWINGS

The present disclosure will become more apparent in view of the attached drawings and accompanying detailed description. The embodiments depicted therein are provided by way of example, not by way of limitation, wherein like reference numerals/labels generally refer to the same or similar elements. In different drawings, the same or similar elements may be referenced using different reference numerals/labels, however. The drawings are not necessarily to scale, emphasis instead being placed upon illustrating aspects of the invention. In the drawings:

FIGS. 1A and 1B present a flowchart of a process of computing a true benefit of a treatment/promotion with respect to one user, according to some embodiments;

FIG. 2 presents a flowchart of a process of computing a true benefit of a treatment/promotion with respect to several users, according to one embodiment;

FIGS. 3A and 3B schematically depict memory configuration for matching users and for computing promotion benefits, according to some embodiments;

FIGS. 4A and 4B depict various time periods relevant to the computation of true benefit of a treatment/promotion, according to various embodiments;

FIG. 5 schematically depicts a user environment in which promotional messages are dynamically delivered to a user device, according to some embodiments;

FIGS. 6A and 6B depict examples true benefits, computed according to various embodiments;

FIG. 7 is an architecture of a computing system implementing some embodiments of the processes for computing the true benefit of a treatment/promotion, according to one embodiment; and

FIG. 8 is a flowchart of benefit computation and dynamic promotion delivery processes, according to some embodiments.

### DETAILED DESCRIPTION

Measuring incremental profit requires estimating the profit users would have generated for a merchant without receiving personalized promotions. Only profit beyond such a “baseline” purchasing behavior is incremental to the merchant and attributable to the personalized promotions. In various embodiments, in order to determine the incremental profit, each “treated” user (a user who receives personalized promotions) is matched to a set of non-treated users (e.g., via credit card data of such users) which exhibit very similar historical purchase and visit behavior over the months prior to the treated user's first transaction at the merchant with a personalized promotion (“pre-period”). The sum average of average transaction totals of the matched cards for a treated user represent a “synthetic” control counterpart for that user. The synthetic control mirrors the behavior of the user in the pre-period, and, moving forward, models the purchases the user would have generated for the merchant in the absence of treatment.

Like a randomized controlled trial, the population of synthetic controls (“control group”) serves to establish a baseline, or counterfactual, for what the sales and visit behavior of the population of users would have been without treatment. The difference in purchases between the treatment and control groups in the post-period measures the incremental sales to the merchant attributable to the personalized offers.

The technique of dynamically creating personalized promotions whenever the data associated with a user changes can produce measurably profitable transactions for a business at which the promotion is created. Prior approaches, like digital coupons delivered via a mobile app, present the same promotion to all users and are unable to measure whether the redemption of the promotion by a user resulted in a profitable transaction for the business.

Comparing the treatment group to a control group that is statistically equivalent across key characteristics, most importantly historical purchase behavior, generally reduces the risk that the measurement of incremental sales and profit are confounded by factors unrelated to treatment. Example unrelated factors accounted for by this method include: a site's organic growth in sales, seasonal purchase patterns, pricing strategy changes, and marketing campaigns. The influence of these external factors will be reflected in the behavior of the control group, effectively raising or lowering the baseline and removing the effect of these factors from the measurement of incrementality.

In various embodiments, promotions are personalized for each user at all retail businesses that are represented by the system. The promotions may be dynamically recalculated by the system whenever the data associated with a user changes, namely:

the historical credit card transaction data owned by the merchant is updated

the current margin amounts for the goods or services being promoted to the user changes

the current location of the user changes

the time of day at which the user interacts with the mobile app changes

the retail businesses that are in the proximity of the user's current location change

the historical personalized promotions that have been previously created for the user change

Each interaction between the user and the mobile app can result in an updated personalized experience for the user that is intended to encourage the user to purchase goods or services that result in measurably more profit for a retail business represented in the system.

### Changing User Purchasing Behavior

In some embodiments, a system described herein includes a server system and a mobile app that are connected together via existing computer networks. The server system dynamically calculates personalized promotions for users and delivers a unique experience every time they interact with the mobile app. The server system continuously receives and analyses one or more of the following data items from which personalized promotions are calculated:

historical credit card transaction data owned by the merchant

the current margin amounts for the goods or services being promoted to the user

the current location of the user

the current time of day

the retail businesses that are in the proximity of the user's current location

the historical personalized promotions that have been previously created for the user

Each time the user interacts with the mobile app, a unique experience is delivered from the server system and displayed on the device. The experience may include an interactive map of retail businesses represented in the system and a personalized promotion for each business. The user may browse the promotions, along with any related information displayed in the mobile app experience, and may select a promotion to redeem. After complying with the terms of the promotion, the value of the promotion is accumulated by the server system and is displayed in the mobile app.

### Measuring Changes to User Purchasing Behavior

It is described below how card matching is conducted for treated users who are either existing customers or new customers of the merchant. Subsequently, the method of calculating incremental profit that is attributable to the personalization of promotions is described, along with an illustrative example.

### Existing Customers

An existing customer is a treated user who was a customer of the merchant before they started receiving the treatment. Specifically, at least one of the user's cards appears in the merchant's transaction history during the user's pre-period. As used herein, a “card” includes a credit card, a debit card, or a mobile payment system. For each of the existing customer's cards appearing in the transaction history, a distance metric is computed between the card's purchase history at the site in the pre-period and all other known cards at the site which do not belong to any other treated user at the site (“candidate control cards”).

The distance metric used can be the standardized Euclidean distance of the purchase history vector (a data structure, in general) of each candidate control card and each user card. A purchase history vector generally has one or more of the following components, which may be defined over the prior months of the treated user's pre-period:

Sales by Month: Amount purchased in each month of the pre-period.

Visits by Month: Number of visits in each month of the pre-period

Category of Sales by Month: Sales and visits behavior are recorded for appropriate distinguished categories of purchases, e.g., fuel purchases, grocery purchases, etc.

It should be understood that a month is only an example of a sub-period of a pre-period. A sub-period can be as small as a few minutes or a few ours, or can be a day, a few days, a week, a few weeks (e.g., 2 or 6 weeks), etc.

A number of candidate control cards, ideally within the maximum permitted distance to the treatment card, are selected as the matched cards. The candidate control cards can be selected using different criteria, one example being a random sampling of cards that fall within the permitted distance. The average of the matched control cards mirrors the purchase history of the existing customer's cards which have transacted at the merchant. Collectively across cards, these matched cards mirror the purchase behavior of the user at the merchant during the pre-period.

### New Customers

A new customer is a treated user for whom no cards appear in the merchant's transaction history during the user's pre-period. Ideally, from a theoretical perspective, a new customer who had not visited prior to their first treated visit would be matched to another potential customer who likewise had not visited up to that point. However, by definition, the cards of potential customers who have not yet visited are not observed in the merchant's transaction history.

As a result, the method measures the incremental profit driven via new customers as follows. The first transaction at a merchant by a treated user who is a new customer is regarded as entirely incremental because they were brought to the merchant by a personalized promotion and had not purchased at the merchant during the pre-period. Then, immediately following the first transaction, the treated user's card is matched to a substantial number of other non-treatment cards that also showed up for the first time that month because they had not purchased at the merchant during the pre-period. The cards are matched in the same manner as the existing customers discussed above, except that the first treated transaction of the treated user is included as part of the purchase history. For all transactions after the first, the new treated customer's purchases are compared to the purchases of the chosen new control group customers to determine incrementality.

The result of the matching process is that new customers are matched to other new customers with very similar purchase histories from the first transaction and going back prior months (reference period, in general) before the evaluation period. Comparing these groups for all transactions after the first, produces a measure of the incremental profit above and beyond the merchant's other available means of generating repeat visits by new customers. Just as with existing customers, the influence of changing pricing strategies, seasonal purchase patterns, and marketing campaigns are removed in this method.

### Measuring Incremental Profit

In some embodiments, the following operations are performed to measure the incremental profit over a given time period.

1. For each treated user who has transacted at the merchant in the time period, the gross profit (transaction sale amount multiplied by transaction margin) is calculated for each of the transactions over the time period from any of the user's cards. Summing the gross profit across the user's transactions yields the gross profit from the user over the time period.

2. Likewise, gross profit is calculated for each of the transactions associated with the non-treatment cards matched to the user. Averaging and summing appropriately across the matched non-treatment cards produces the baseline expected gross profit for the user over the time period.

3. Subtracting the expected gross profit from the user's gross profit yields the incremental profit from the user driven to the merchant by the treatment.

4. Finally, aggregating incremental profit across the treated users produces the incremental profit net of promotions driven by the treatment to the merchant over the time period.

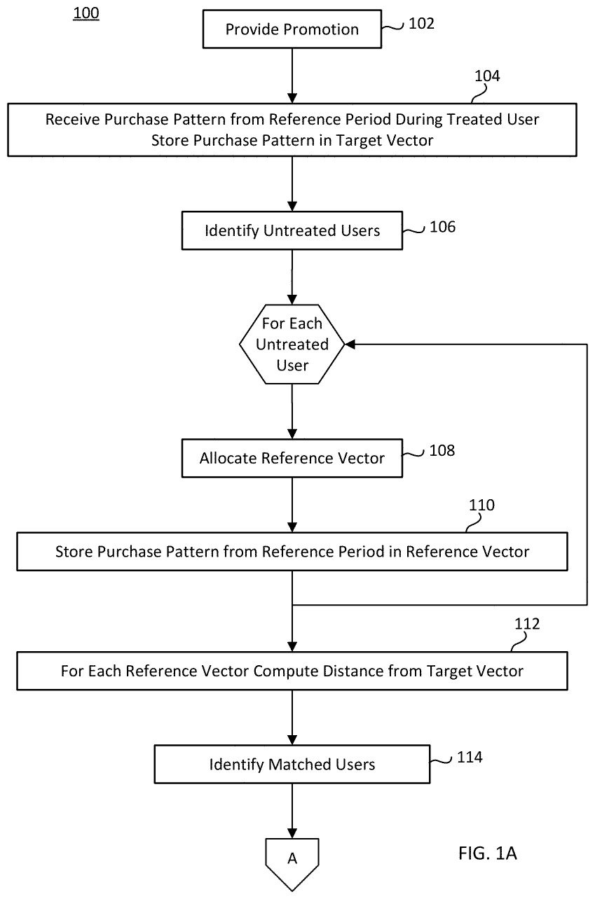

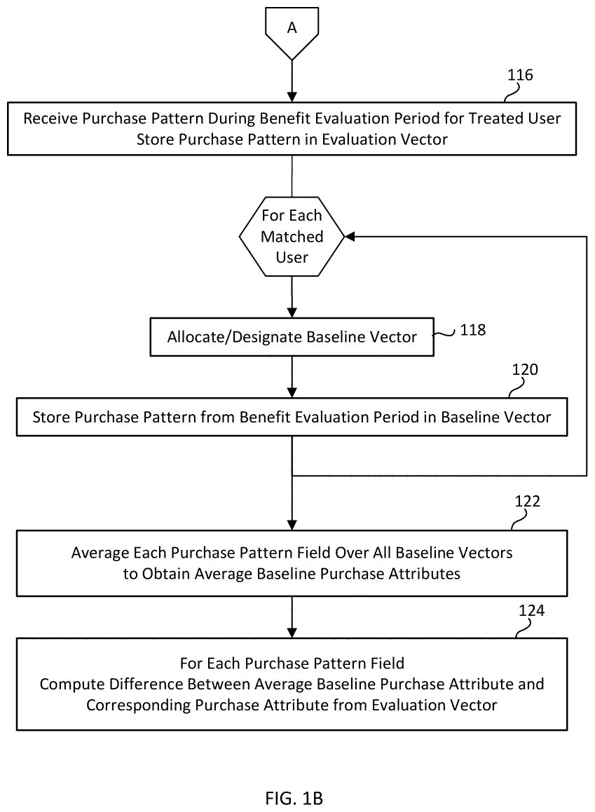

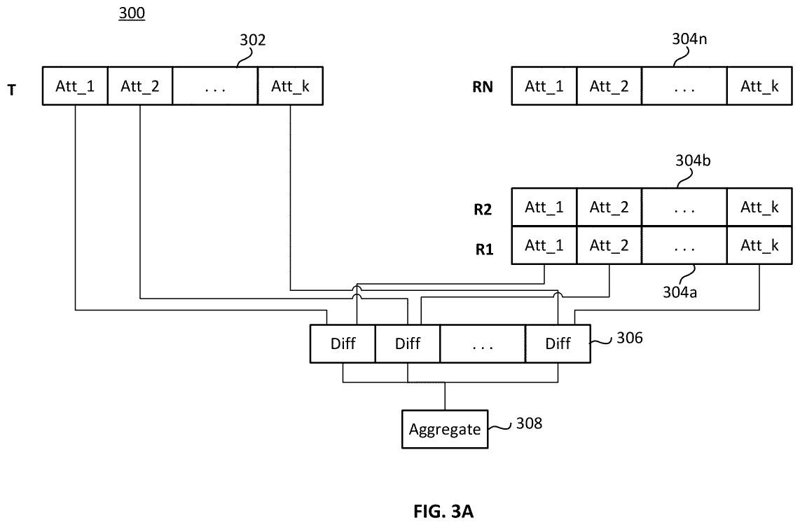

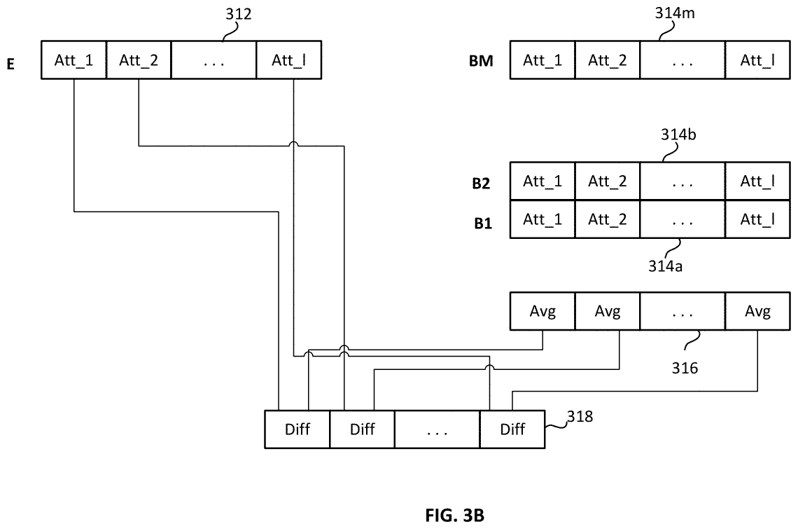

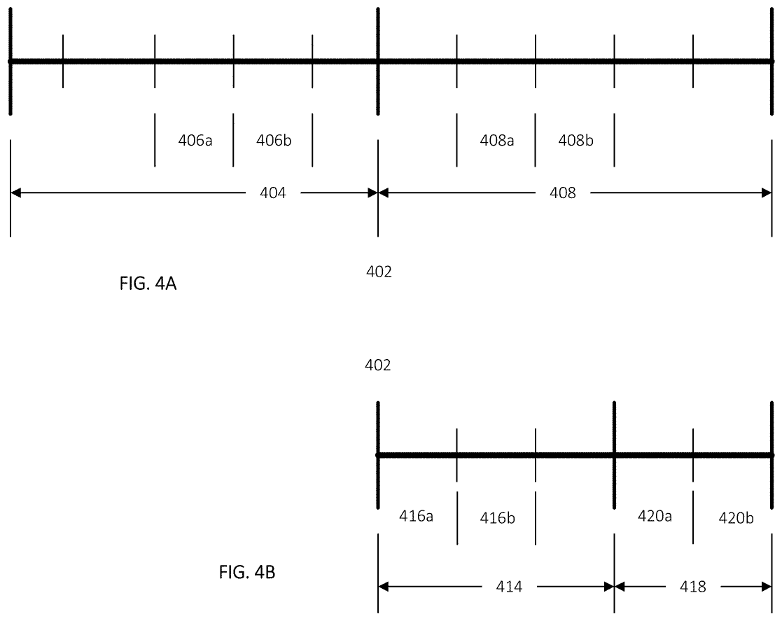

With reference to FIGS. 1A and 1B, in a process 100 for determining the true benefit of a promotion, a promotion, also called a treatment, is provided to one or more users via their mobile devices (step 102). A purchase pattern is received from within a reference period (also referred to as pre-period) for a treated user, and stored in a target vector (step 104). Memory space may be allocated for the target vector in the memory of the computing system. The target vector is described with reference to FIGS. 3A and 3B. The reference period is shown in FIGS. 4A and 4B. Several untreated uses, e.g., users that have not received the promotion, are selected or identified (step 106). The treated and untreated users can be existing users or new users, as described above.

For each untreated user, a reference vector is allocated (step 108). The reference vector is also described with reference to FIGS. 3A and 3B. Moreover, for each untreated user, a purchase pattern from within the reference period is received, and stored in the allocated reference vector (step 110). For each reference vector, the distance thereof from the target vector is computed (step 112). The computation of the distance is described with reference to FIG. 3A. Also for each reference vector, the computed distance is compared with a specified threshold distance and the reference vectors for which the computed distance does not exceed the specified threshold are selected (step 114). The users associated with the selected reference vectors are designated as matched users (step 114).

Furthermore, a purchase pattern from within a benefit-evaluation period is received for the treated user, and stored in an evaluation vector (step 116). The memory space that was allocated to the target vector may be reallocated to the evaluation vector, or a different memory space may be allocated for the evaluation vector, in the memory of the computing system. The evaluation vector is described with reference to FIGS. 3A and 3B. The benefit-evaluation period (also called the evaluation period or post-period) is shown in FIGS. 4A and 4B.

Additionally, for each matched user, a baseline vector is allocated or designated (step 118). In some embodiments, the respective reference vectors for the matched users may be re-designated as the respective baseline vectors. In some embodiments, additional memory space may be allocated for the baseline vectors. The re-designation can reduce the memory footprint and can increase the memory efficiency of the computing system. Allocation of additional memory, on the other hand, can enhance performance. For example, the reference vectors can be compared with different target vector(s) of different treated user(s), without having to regenerate such reference vectors. Such comparisons may be performed, at least partially, in parallel.

For each matched user, the purchase pattern thereof from the benefit evaluation period is stored in the respective baseline vector (step 120). For each field in the baseline vector, an average is computed over all baseline vectors, to obtain an average baseline purchase attributes corresponding to that field (step 122). Moreover, for each purchase pattern field, e.g., for each field in the base line vector, the difference between the respective average baseline purchase attribute and the corresponding purchase attribute from the evaluation vector is computed, to indicate the true benefit of the treatment, such as the promotion, with respect to the particular treated user (step 124).

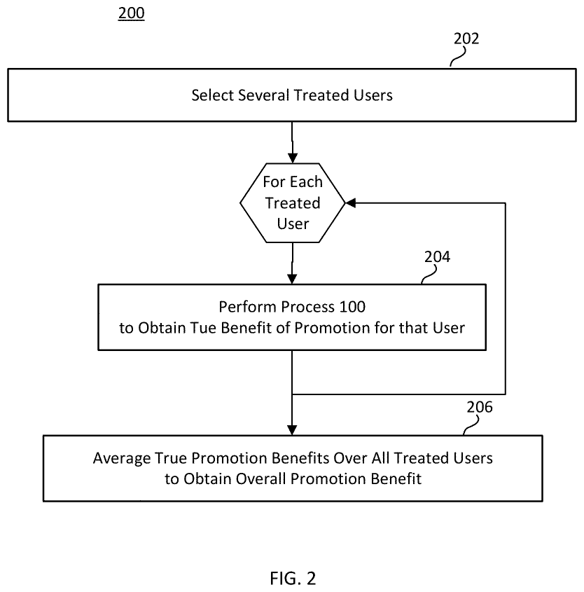

With reference to FIG. 2, in an envelope process 200, several treated users, all of which received a particular treatment, are selected (step 202). The process 100 (FIGS. 1A and 1B) is repeated for the selected treated users (step 204), and the true benefit of the treatment for all the selected treated users is averaged (step 206), to provide an average (also called aggregate or overall) true benefit of the treatment (step 208).

The above-described memory and/or processing efficiency tradeoff may be amplified in the envelope process 200. In particular, if the memory space is allocated separately for all the reference and baseline vectors for several treated users, the overall memory required by the envelope process 200 can be substantial. On the other hand, if the memory space initially allocated to the reference vectors is reallocated to or reused for the baseline vectors, a substantial reduction in the memory footprint of the envelope process can be obtained. In some cases, the memory space can be reused across one or more treated users, resulting in a further reduction in the memory footprint.

By allocating separate memory spaces for the reference and baseline vectors and/or separate memory spaces across several treated users, various instances of the process 100, as part of the envelope process 200, can be executed, at least partially, in parallel. One or more of the individual steps of one or more process instances 100 may also be executed, at least partially, in parallel. Such parallel processing, though requiring a greater amount of memory than when memory reallocation is performed, can speed up the execution of processes 100 and 200. This can also avoid duplicate computations, such as regeneration of the reference and/or benefit vectors across different treated users, so that performance enhancement can be achieved even without parallelized computations.

With reference to FIG. 3A, a target vector “T” includes “k” fields identified as Att_1, Att_2, . . . , Att_k. Each field corresponds to a particular attribute of a purchase pattern, as discussed above. Memory space 302 is allocated for the target vector T. Typically, but not necessarily, contiguous memory space is allocated for all the fields of the target vector T. Reference vectors R1, R2, through RN correspond to N untreated users. The number of untreated users (N) can be any number such as 10; 50; 300; 2,000; 100;000; or more. For the reference vectors R1, R2, . . . RN, respective memory spaces 304a, 304b, . . . , 304n are allocated. Each reference vector has the same fields as the target vector T and typically, but not necessarily, the memory space allocated to a particular reference vector is contagious. In some cases, the memory space allocated for all N reference vectors, or at least a subset thereof, is contiguous, which can enhance the performance of the processes 100, 200 (FIGS. 1A, 1B, and 2), by speeding up memory read/write operations with respect to the reference vectors.

For each attribute 1 through k, a difference between the corresponding values of that attribute in the target vector T and the reference vector R1 is computed, to obtain a difference vector 306. The attribute-level differences are aggregated, e.g., as a simple sum, a weighted sum, a quantized sum, a quantized weighted sum, etc., to obtain a distance between the target vector T and the reference vector R1. Alternatively or in addition, the computation of the distance may be based on statistical measures (e.g., mean, variance, other moments) of attributes of the target vector T and the reference vector R1 and may be performed using techniques such as T test, clustering, etc. The computation of the distance is repeated for all the other reference vectors R2 through RN, to obtain a distance of the target vector from each of the reference vectors R1 through RN. These distances are used, as described above, to select the matching users.

With reference to FIG. 3B, an evaluation vector “E” includes “l” fields identified as Att_1, Att_2, . . . , Att_l. Each field corresponds to a particular attribute of a purchase pattern, as discussed above. The number of attributes (k, as shown in FIG. 3A and l, as shown in FIG. 3B) can be any numbers such as 1, 2, 5, 8, 15, or more. The numbers k and l can be the same or they can be different. Memory space 312 is allocated for the evaluation vector E. Typically, but not necessarily, contiguous memory space is allocated for all the fields of the target vector E.

Baseline vectors B1, B2, through BM correspond to M untreated matched users. The number of untreated matched users (M) can be any number such as 10; 50; 300; 2,000; 100;000; or more. Typically, the number of matched users M is less than the total number of untreated users N. For the baseline vectors B1, B2, . . . BN, respective memory spaces 314a, 314b, . . . , 314m may be allocated. Alternatively, as discussed above, the memory space initially allocated to a corresponding reference vector may be reallocated to a baseline vector.

Each baseline vector has the same fields as the evaluation vector E and typically, but not necessarily, the memory space allocated to a particular baseline vector is contagious. In some cases, the memory space allocated for all M baseline vectors, or at least a subset thereof, is contiguous, which can enhance the performance of the processes 100, 200 (FIGS. 1A, 1B, and 2), by speeding up memory read/write operations with respect to the baseline vectors.

For each attribute 1 through l, an average of the corresponding values from the baseline vectors B1 through BM is computed, to obtain an average baseline attribute value. For each attribute 1 through l, a difference between the corresponding values of that attribute in the evaluation vector E and the average baseline value is computed, to obtain a true benefit with respect to that attribute. The attribute-level benefits, represented as a benefit vector 318, may be aggregated, e.g., as a simple sum, a weighted sum, a quantized sum, a quantized weighted sum, etc., to obtain a true benefit of providing a promotion to the treated user. This computation can be performed for several treated users, one or more of which may have different respective sets of matched users. As described in process 200 (FIG. 2), the true benefits of a particular promotion for several treated users can be averaged to obtain an overall benefit of the promotion.

With reference to FIGS. 4A and 4B, the current or present time is shown at 402. For existing users, the period 404 is the reference period (also called pre-period), which may be divided into sub-pre-periods 406a, 406b, etc. The period 408 is the benefit-evaluation period (also called the evaluation period or post-period), which may be divided into sub-post-periods 410a, 410b, etc. The periods 404, 406, 408, 410 can be short, such as a few minutes or few hours in duration, or can be a day, a few days, a few weeks, or a few months.

For new users, the period 414 is the reference period, which begins at the present time 402 and may be divided into sub-pre-periods 416a, 416b, etc. The period 418 is the benefit-evaluation period, which begins after the reference period ends, and may be divided into sub-post-periods 420a, 420b, etc. The periods 414, 416, 418, 420 can also be short, such as a few minutes or few hours in duration, or can be a day, a few days, a few weeks, or a few months.

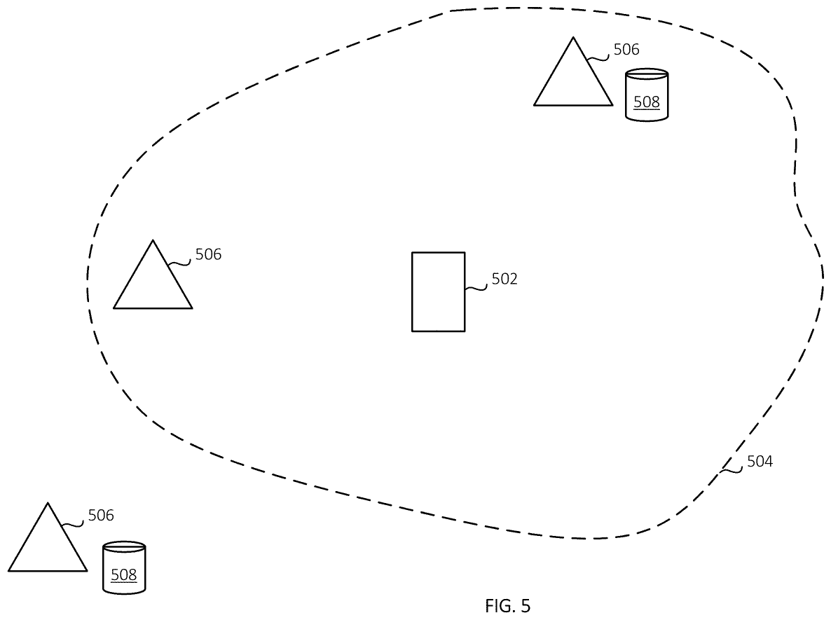

With reference to FIG. 5, a treatment, or a promotional message may be displayed or dynamically updated on a remote device, such as a mobile/smart phone, tablet, etc., as follows. A device identifier and the location of the remote device 502 is received. In some cases, the speed at which the location of the remote device is changing, i.e., the speed at which the remote device is moving, may also be received. The speed can vary substantially from situations when the user is walking about, for example in a mall, or an amusement park, to situations where the user may be moving in a car. Using the device identifier, the user of the remote device 502 is identified.

A geo-perimeter 504 is generated based on the location of the device 502. In some cases, the size of the geo-perimeter may be based on the received speed of movement of the remote device. Typically, but not necessarily, the greater the speed of the movement, the larger the size of the geo-perimeter. A set of one or more business entities 506 within the geo-perimeter 504 is selected. Not all the entities detected within the geo-perimeter may be included in the set.

Based on one or more device parameter of the remote device 502, a command causing the remote device 502 to display thereon a promotional message is generated and transmitted to the remote device 502. The device parameters may include screen size, screen resolution, device type, device operating system, etc. The promotional message is based on, at least in part, a number of message-selection parameters such as information in the respective databases 508 of one or more of the selected set of business entities 506. These databases may include information regarding the purchasing behavior of the user of the device 502 and/or information regarding the purchasing behaviors of other users.

The message selection parameters may also include the time of the day, the location of the remote device 502, and/or the history of promotional messages previously transmitted to the remote device. The history may also include the user's response to a previously transmitted message, such as ignoring/not viewing the message; viewing, but not taking any action; or taking an action with respect to the promotional message, such as buying a product/service promoted in the message, visiting a different vendor, etc. The user's reaction or non-reaction may be recorded during a specified time window after a promotional message is displayed, e.g., within a few seconds or minutes, a few hours, a few days, etc.

A change in one or more message selection parameters is detected, where the change can be a change in any of the parameters described above. Thereafter, based on one or more device parameters of the remote device, another command is generated and transmitted to the remote device 502. The other command is designed to cause a promotional message to be displayed on the remote device 502, where the other promotional message is based on, at least in part, the detected change in the one or more of the message-selection parameters.

Thus, promotional messages are displayed in a dynamic manner based on not only the geo-location of the remote device and a geo-perimeter, but also based on, at least in part, real-time changes in the information pertinent to the user of the remote device 502. In this context, real-time generally means during a time window of a few second, a few minutes, a few hours or, in some cases, a few days.

As described above, the database 508 of a particular business entity 506 may include information about the purchase/transaction history of the user of the device 502, where the user may have purchased products or services from that business entity. The purchase/transaction history may also include visit history (e.g., number of visits, frequency of visits, etc.), where the user visited the business entity's store. The purchase/transaction history may also include a product return history. In some cases, the database 508 may include an inventory of one or more products, and a change in the database can be a change in the inventory.

If a change in the location of the remote device 502 is detected, the geo-perimeter may be revised in response to the location change. The set of business entities may also be revised, e.g., by including one or more new entities and/or by excluding one or more entities, based on the revised geo-perimeter.

### EXAMPLE

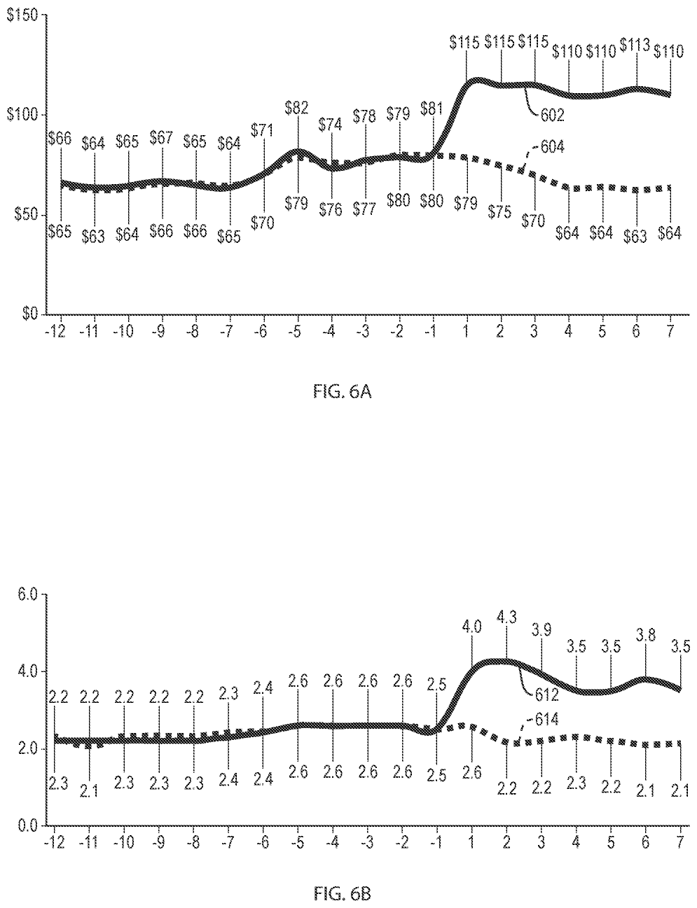

Consider the incremental calculation for an example grocery store site over the period Jan. 1, 2018 (launch date) through Jul. 31, 2018. Over this period, a treatment group of 1,500 users completed 12,000 reconciled transactions in a test app at the site. These users used 5,000 unique card IDs to complete these transactions. The curves 602, 612 in FIGS. 6A and 6B, respectively, depict the average monthly sales and visits from these users in the 12 months before their first transaction at the grocery store and up to 7 months afterward.

### Matching

A pool of all the non-treatment cards which have transacted at the grocery store was searched to match each of the 5,000 treatment cards with an average of five of the closest matches based on the pre-treatment sales and visit history. For example, a test app user associated with two card IDs may be matched to five synthetic users each of which also have two associated card IDs for a total of ten cards matched to this test app user. Since matching occurs with replacement, these ten cards are available as potential matches for the other test app users.

The curves 604, 614 in FIGS. 6A and 6B depict the average sales and visits of the synthetic controls over the period of available data. Note the relative close alignment of the two groups in the pre-period. T-tests of the difference in mean visits and sales reveal no statistically significant differences between the groups. As expected, matching has been successful in constructing a control group that mirrors the pre-treatment purchase and visit history of the test app users—allowing for a more reliable comparison in the post-treatment period.

### Measurement of Incremental Profit per User

Now that the test app user's cards have been matched to the non-test-app control cards, the next step is to compute the gross incremental profit for each user. As detailed in the previous section, the gross profit of each user's matched group is subtracted from the user's gross profit over the time period. As a result, on average across users in this example, $31.50 of incremental profit per user was generated over this time period.

### Incremental Profit

Summing the gross profit per user across the 1,500 users at the site yields $47,250 in incremental profit for the merchant. Subtracting a total promotion cost of $13,000 yields $34,250 in incremental profit net of promotion costs over the period.

### System Architecture

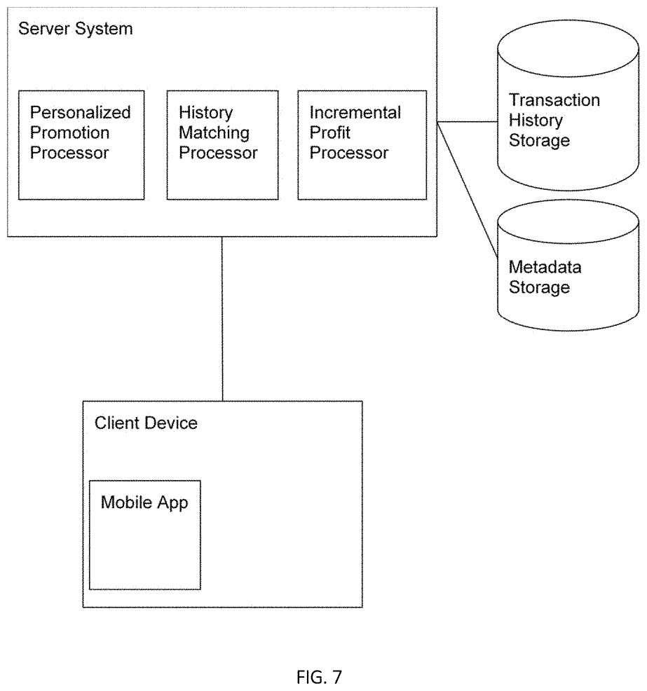

With reference to FIG. 7, in some embodiments, the system includes a Server System, which is a combination of hardware and software, that is connected over standard TCP/IP networks to one or more Client Devices. The Server System may include several processor and storage components. The Transaction History Storage is utilized by the History Matching Processor to determine the non-treatment cards that match the treated user's cards.

The Personalized Promotion Processor utilizes both the Transaction History Storage and the Metadata Storage to calculate a personalized promotion value for the user, for each retain business represented by the system, based on one or more of the following continuously updated Metadata:

historical credit card transaction data owned by the merchant

the current margin amounts for the goods or services being promoted to the user

the current location of the user

the current time of day

the retail businesses that are in the proximity of the user's current location

the historical personalized promotions that have been previously created for the user

The Incremental Profit Processor measures the incremental profit created by each user at each business. The Client Device is operated by a user and displays, via a mobile app installed on the Client Device, a unique visual representation of proximate retail businesses and personalized promotions for the user at the businesses. The visual representation dynamically changes on each new user interaction with the mobile app.

One implementation of the Server System is a cloud-based service that is accessible to Client Devices via TCP/IP networks. A Baseline Service at the Server System records the non-treatment cards that are matched to a treated user's cards. A Merchant Service at the Server System records information about each site, e.g., available margin for each transaction, that is used to calculate personalized promotions for users that are displayed on a Client Device. The Transaction History Storage records the historical transaction summary data for each site and is continually updated with the most recent transaction data for each site as it becomes available.

Various embodiments described herein operate within a computer network that connects the Server System to Client Devices. Each Client Device is associated with a user who receives personalized promotions for merchant locations that are represented in the Server System. Historical transaction data is acquired by the Server System for each merchant location and is stored in the Transaction History Storage.

A Merchant interacts with the Server System by granting access to the historical transaction data for each location, e.g., gas station/restaurant/grocery/etc., at which the merchant wishes to provide personalized promotions to users. A User interacts with the Client Device, e.g., a smartphone, to connect to the Server System over standard TCP/IP networks to receive personalized promotions at each merchant location represented by the Server System.

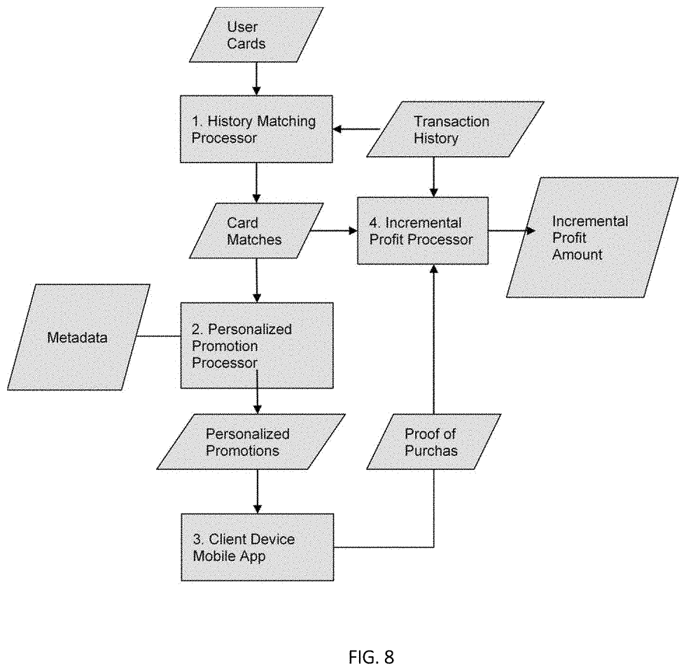

With reference to FIG. 8, in some embodiments:

1. The History Matching Processor creates a significant number of Card Matches for each collection of User Cards against the Transaction History Storage.

2. The Personalized Promotion Processor uses Card Matches to create Personalized Promotions for the User.

3. The Personalized Promotions are retrieved by the Mobile App on the Client Device.

4. After the user selects a promotion and completes a transaction at the business, a Proof of Purchase is verified by the Incremental Profit Processor and it calculates the Incremental Profit Amount of the transaction.

One technical benefit of the processing and systems described herein is that determination of a relevant treatment or promotion is based not only the current location of the user, as indicated by the user's device and the neighborhood of the user, as determined by the geo-perimeter, but also takes into account, in real time, the user's response or lack thereof to similar treatments/promotion provided to the user in the past. Another technical benefit of the processing and systems described herein is that during the computation of the true benefit of a treatment/promotion, the memory allocation can controlled to explore and take advantage of a tradeoff between memory usage and processor cycles, processor time, and/or execution time, and parallelizability of the computation.

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

A computing system used to implement various embodiments may include general-purpose computers, vector-based processors, graphics processing units (GPUs), network appliances, mobile devices, or other electronic systems capable of receiving network data and performing computations. A computing system in general includes one or more processors, one or more memory modules, one or more storage devices, and one or more input/output devices that may be interconnected, for example, using a system bus. The processors are capable of processing instructions stored in a memory module and/or a storage device for execution thereof. The processor can be a single-threaded or a multi-threaded processor. The memory modules may include volatile and/or non-volatile memory units.

The storage device(s) are capable of providing mass storage for the computing system, and may include a non-transitory computer-readable medium, a hard disk device, an optical disk device, a solid-date drive, a flash drive, or some other large capacity storage devices. For example, the storage device may store long-term data (e.g., one or more data sets or databases, file system data, etc.). The storage device may be implemented in a distributed way over a network, such as a server farm or a set of widely distributed servers, or may be implemented in a single computing device.

The input/output device(s) facilitate input/output operations for the computing system and may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices. In some examples, mobile computing devices, mobile communication devices, and other devices may be used as computing devices.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium.

Various embodiments and functional operations and processes described herein may be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein is for the purpose of description and should not be regarded as limiting. The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A method for dynamically controlling a display of a remote device, the method comprising performing by a server the steps of:
receiving from a remote device, a device identifier and a location of the remote device;
identifying, using the device identifier, a user of the remote device;
generating a geo-perimeter based on the location, and selecting a set of one or more business entities within the geo-perimeter;
generating, based on a device parameter of the remote device, and transmitting thereto a first command causing a first promotional message to be displayed on the remote device, the first promotional message being based on, at least in part, a plurality of message-selection parameters;
detecting a change in one or more of the plurality of message-selection parameters, the change comprising one or more of: a change in respective databases of a subset of the selected set of one or more business entities, a change in time of the day, a change in the location of the remote device, or a change in history of promotional messages transmitted to the remote device; and
generating, based on a device parameter of the remote device, and transmitting thereto a second command causing a second promotional message to be displayed on the remote device, the second promotional message being based on, at least in part, the change in the one or more of the plurality of message-selection parameters.

2. The method of claim 1, wherein the device parameter comprises a type of the remote device or a size of a display of the remote device.

3. The method of claim 1, wherein:
the subset of the selected set of one or more business entities comprises a first business entity;
a database of the first business entity comprises a history of transactions of a plurality of users with the first business entity; and
a change in the database of the first business entity comprises a change in the history of transactions.

4. The method of claim 1, wherein:
the subset of the selected set of one or more business entities comprises a first business entity;
a database of the first business entity comprises an inventory of a plurality of products; and
a change in the database of the first business entity comprises a change in the inventory.

5. The method of claim 1, wherein a change in the location of the remote device is detected, the method further comprising:
revising the geo-perimeter based on the changed location; and
revising the set of one or more business entities based on the revised geo-perimeter.

6. The method of claim 1, wherein the change in history of promotional messages transmitted to the remote device comprises one or more of:
an entry of the first promotional message in the history of promotional messages; or
an entry of a user reaction or non-reaction during a selected time window to the first promotional message.

7. A method for determining a baseline for a treatment benefit, the method comprising:
receiving and storing a purchase pattern during a reference period, of a treated user, in a target vector having a plurality of fields, wherein each field corresponds to a respective attribute of the purchase pattern;
for each untreated user:
allocating in memory, memory space for a respective reference vector, the reference vector having the same plurality of fields; and
storing in the respective reference vector, a purchase pattern during the reference period, of the untreated user;
for each reference vector, computing a distance thereof with the target vector, the distance being based on a field-wise comparison of the reference and target vectors; and
selecting reference vectors having respective distances not exceeding a specified threshold, and designating corresponding users as matched users.

8. The method of claim 7, wherein:
the treated and untreated users comprise existing users; and
the reference period precedes a benefit evaluation period.

9. The method of claim 7, wherein:
the treated and untreated users comprise new users; and
the reference period commences upon a first transaction by the treated user and precedes a benefit evaluation period.

10. The method of claim 7, wherein:
the field-wise comparison comprises computing a field difference for each field; and
computing the distance comprises computing a weighted sum of the field differences.

11. The method of claim 7, wherein an attribute of the purchase pattern is selected from the group consisting of: an amount purchased during a sub-period of the reference period; a count of transactions during the sub-period; an amount purchased during the sub-period for a selected category; and a count of transactions during the sub-period for the selected category.

12. The method of claim 7, further comprising:
receiving and storing a purchase pattern during a benefit-evaluation period, of the treated user, in an evaluation vector having one or more fields, each field corresponding to a respective attribute of the purchase pattern;
for each matched user, storing in a respective baseline vector having the one or more fields, a purchase pattern during the benefit evaluation period, of the matched user;
for each field in the one or more fields:
averaging corresponding purchase pattern attributes over the baseline vectors to provide a corresponding average baseline purchase pattern attribute; and
computing a difference between the evaluation vector and the average baseline purchase pattern attribute, to determine a benefit of a treatment.

13. The method of claim 12, wherein same memory space is allocated to each reference vector and corresponding baseline vector, to improve memory efficiency.

14. The method of claim 12, further comprising:
allocating in the memory, memory space for each baseline vector, the respective memory spaces of the corresponding reference and baseline vectors being different, to improve processor performance.

15. The method of claim 12, wherein the benefit evaluation period is subsequent to the reference period.

16. A system for dynamically controlling a display of a remote device, the system comprising:
a processor; and
a memory coupled to the processor and comprising instructions, which when executed by the processor, program the processor to:
receive from a remote device, a device identifier and a location of the remote device;
identify, using the device identifier, a user of the remote device;
generate a geo-perimeter based on the location, and selecting a set of one or more business entities within the geo-perimeter;
generate, based on a device parameter of the remote device, and transmit thereto a first command causing a first promotional message to be displayed on the remote device, the first promotional message being based on, at least in part, a plurality of message-selection parameters;
detect a change in one or more of the plurality of message-selection parameters, the change comprising one or more of: a change in respective databases of a subset of the selected set of one or more business entities, a change in time of the day, a change in the location of the remote device, or a change in history of promotional messages transmitted to the remote device; and
generate, based on a device parameter of the remote device, and transmit thereto a second command causing a second promotional message to be displayed on the remote device, the second promotional message being based on, at least in part, the change in the one or more of the plurality of message-selection parameters.

17. The system of claim 16, wherein the device parameter comprises a type of the remote device or a size of a display of the remote device.

18. The system of claim 16, wherein:
the subset of the selected set of one or more business entities comprises a first business entity;
a database of the first business entity comprises a history of transactions of a plurality of users with the first business entity; and
a change in the database of the first business entity comprises a change in the history of transactions.

19. The system of claim 16, wherein:
the subset of the selected set of one or more business entities comprises a first business entity;
a database of the first business entity comprises an inventory of a plurality of products; and
a change in the database of the first business entity comprises a change in the inventory.

20. The system of claim 1, wherein the instructions program the processor to, upon detecting a change in the location of the remote device:
revise the geo-perimeter based on the changed location; and
revise the set of one or more business entities based on the revised geo-perimeter.

21. The method of claim 1, wherein the change in history of promotional messages transmitted to the remote device comprises one or more of:
an entry of the first promotional message in the history of promotional messages; or
an entry of a user reaction or non-reaction during a selected time window to the first promotional message.

22. A system for dynamically controlling a display of a remote device, the system comprising:
a processor; and
a memory coupled to the processor and comprising instructions, which when executed by the processor, program the processor to:
receive and store a purchase pattern during a reference period, of a treated user, in a target vector having a plurality of fields, wherein each field corresponds to a respective attribute of the purchase pattern;
for each untreated user:
allocate in memory, memory space for a respective reference vector, the reference vector having the same plurality of fields; and
store in the respective reference vector, a purchase pattern during the reference period, of the untreated user;
for each reference vector, compute a distance thereof with the target vector, the distance being based on a field-wise comparison of the reference and target vectors; and
select reference vectors having respective distances not exceeding a specified threshold, and designate corresponding users as matched users.

23. The system of claim 22, wherein:
the treated and untreated users comprise existing users; and
the reference period precedes a benefit evaluation period.

24. The system of claim 22, wherein:
the treated and untreated users comprise new users; and
the reference period commences upon a first transaction by the treated user and precedes a benefit evaluation period.

25. The system of claim 22, wherein:
to perform the field-wise comparison, the instructions program the processor to compute a field difference for each field; and
to compute the distance, the instructions program the processor to compute a weighted sum of the field differences.

26. The system of claim 22, wherein an attribute of the purchase pattern is selected from the group consisting of: an amount purchased during a sub-period of the reference period; a count of transactions during the sub-period; an amount purchased during the sub-period for a selected category; and a count of transactions during the sub-period for the selected category.

27. The system of claim 22, wherein the instructions further program the processor to:
receive and store a purchase pattern during a benefit-evaluation period, of the treated user, in an evaluation vector having one or more fields, each field corresponding to a respective attribute of the purchase pattern;
for each matched user, store in a respective baseline vector having the one or more fields, a purchase pattern during the benefit evaluation period, of the matched user;
for each field in the one or more fields:
average corresponding purchase pattern attributes over the baseline vectors to provide a corresponding average baseline purchase pattern attribute; and
compute a difference between the evaluation vector and the average baseline purchase pattern attribute, to determine a benefit of a treatment.

28. The system of claim 27, wherein the instructions program the processor to allocate same memory space to eachreference vector and corresponding baseline vector, to improve memory efficiency.

29. The system of claim 27, wherein the instructions further program the processor to:
allocate in the memory, memory space for each baseline vector, the respective memory spaces of the corresponding reference and baseline vectors being different, to improve processor performance.

30. The system of claim 27, wherein the benefit evaluation period is subsequent to the reference period.
